(19) United States
(12) Patent Application Publication
(10) Pub. No.: US 2012/0046970 A1
(43) Pub. Date: Feb. 23, 2012

(54) CONTROLLED SUBSTANCE DISTRIBUTION SYSTEM

(76) Inventors: Thomas John Potts, West Chester, PA (US); Thomas Ian Potts, West Chester, PA (US)

(21) Appl. No.: 13/215,670

(22) Filed: Aug. 23, 2011

Related U.S. Application Data
(60) Provisional application No. 61/376,121, filed on Aug. 23, 2010.

(51) Int. Cl. G06Q 50/00

(52) U.S. Cl. 705/3

(57) ABSTRACT

A controlled substance distribution system may include a controlling entity having a database. The database may include data associated with a patient, an amount of a controlled substance that the patient is authorized to receive, and an amount of the controlled substance that the patient has already received during a time period. The system may include a token having a unique identifier. The data may include data that is associated with the unique identifier. The system may include a dispensing center having a computing device in communication with the controlling entity. The computing device may be configured to obtain the unique identifier from the token, transmit the unique identifier and a request for the controlled substance to the controlling entity, receive an indication of whether or not the request is allowed, and authorize a dispensing event in response to the request if the indication indicates that the request is allowed.

### CROSS-REFERENCE TO RELATED APPLICATIONS

This application claims the priority benefit of U.S. Provisional Patent Application No. 61/376,121 filed on Aug. 23, 2010.

Not Applicable

### BACKGROUND

Medical cannabis (also known as medical marijuana) has been found to provide several beneficial effects as a course of medical treatment. These effects include reduction in nausea and vomiting, hunger stimulation for patents undergoing chemotherapy or treatment for AIDS, and general pain relief. However, marijuana is also a controlled substance whose distribution is limited by law in certain jurisdictions, and entirely banned in other jurisdictions.

Jurisdictions that have permitted the distribution of marijuana for medical use often struggle to find methods and systems that ensure that the substance is only distributed for its permitted purpose. While systems have been developed to help ensure that the substance is only distributed to authorized patients, no system helps ensure that the patients do not receive amounts sufficient to redistribute to others. In addition, no system helps track the substance from initial packaging until a dispensing event.

The methods and systems described in this document can help to resolve some or all of the issues described above relating to the distribution of controlled substances such as medical cannabis.

### SUMMARY

In an embodiment, a controlled substance distribution system may include a controlling entity that includes a database. The database may include data associated with a patient, an amount of a controlled substance that the patient is authorized to receive via disbursement from one or more authorized dispensing entities during a time period, and an amount of the controlled substance that the patient has already received during the time period. The controlled substance distribution system may include a patient token having a unique patient identifier. The data in the database may include data that is associated with the unique patient identifier. The controlled substance distribution system may include a dispensing center having a computing device in communication with the controlling entity. The computing device may be configured to obtain the unique patient identifier from the patient token, transmit the unique patient identifier and a request for the controlled substance to the controlling entity, receive, from the controlling entity, an indication of whether or not the request is allowed, and authorize a dispensing event in response to the request only if the indication indicates that the request is allowed.

In an embodiment, a controlled substance distribution system may include a controlling entity in communication with a dispensing center. The controlling entity may include a computing device in communication with a database. The database may include a unique patient identifier associated with a patient, an allotted amount of a controlled substance that the patient is authorized to receive via dispensing from one or more authorized dispensing entities during a time period, and an obtained amount of the controlled substance that the patient has already received during the time period. The computing device may be configured to receive a request from the dispensing center to dispense a controlled substance to the patient, and in response to a sum of the requested amount and the obtained amount exceeding the allotted amount, send a communication to the computing device. The communication may include an indication that the request is denied, and the request may include the patient identifier associated with the patient and a requested amount of the controlled substance.

In an embodiment, a controlled substance distribution system may include a controlling entity in communication with a dispensing center. The controlling entity may include a computing device in communication with a database. The database may include a patient identifier associated with a patient, a caregiver identifier associated with a caregiver for the patient, an allotted amount of a controlled substance that the patient is authorized to receive via dispensing from one or more authorized dispensing entities during a time period, and an obtained amount of the controlled substance that the patient has already received during the time period. The computing device may be configured to receive a request from the dispensing center to dispense a controlled substance to the patient, and in response to the provided caregiver identifier matching the caregiver identifier and a sum of the requested amount and the obtained amount not exceeding the allotted amount, send a communication to the dispensing center. The request may include the patient identifier associated with the patient, a provided caregiver identifier and a requested amount of the controlled substance. The communication may include an indication that the request is allowed.

### BRIEF DESCRIPTION OF THE DRAWINGS

FIG. 1 illustrates exemplary elements of a controlled substance distribution system.

FIG. 2 illustrates an exemplary method of tracking a controlled substance according to an embodiment.

FIG. 3 illustrates exemplary people, entities, organizations and/or the like whose activities a controlling entity may monitor or otherwise track according to an embodiment.

FIG. 4 illustrates a block diagram of exemplary internal hardware that may be used to contain or implement program instructions according to an embodiment.

### DETAILED DESCRIPTION

Methods and systems for distributing a controlled substance, such as medical cannabis, are described below. As used in this document, the term “controlled substance” means a drug whose distribution, possession and use are controlled by law.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

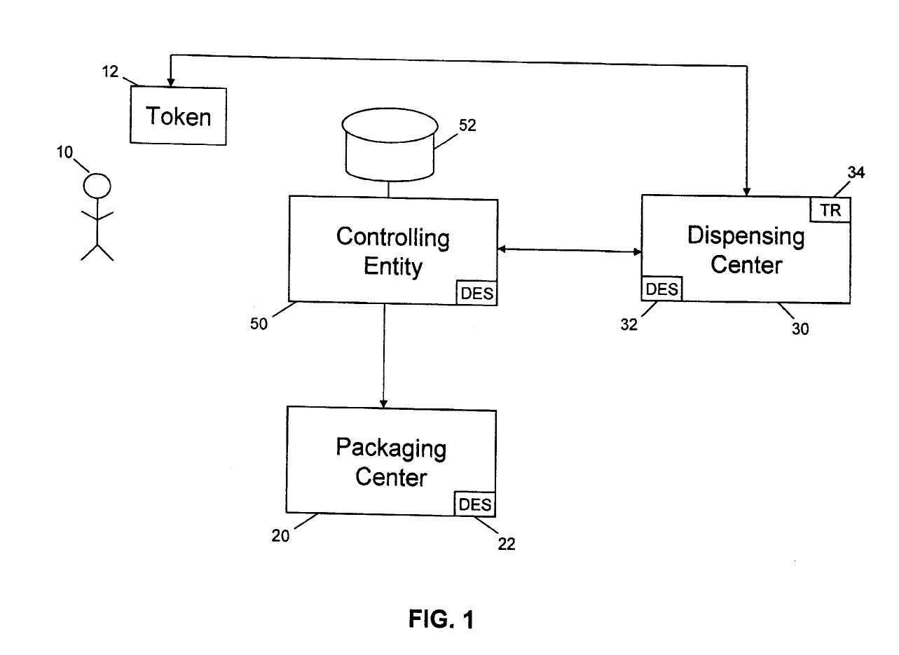

FIG. 1 illustrates various aspects of a controlled substance distribution system according to an embodiment. In an embodiment, any person 10 who is authorized by law to possess and use a controlled substance may be issued a registry identification token 12. For example, a patient who has been prescribed medical cannabis for therapeutic purposes may be issued a token 12. The token 12 may be issued by an agency of the state or other political jurisdiction that regulates the controlled substance. Alternatively, it may be issued by an issuing entity that has been authorized by the jurisdiction to issue the token 12.

In an embodiment, a token 12 may be a card with a magnetic strip, a radio frequency identification (RFID) tag, a computer-readable memory, a data storage device and/or other means to store a unique identification code that can be transferred to a token reader at a dispensing center 30. Alternatively, a token 12 may be part of another device such as key fob, a wearable accessory such as a bracelet, a mobile phone, and/or another device. If a token 12 is lost or stolen, the person to whom the token belongs may not be issued a new token until the original token is deactivated and/or de-authorized.

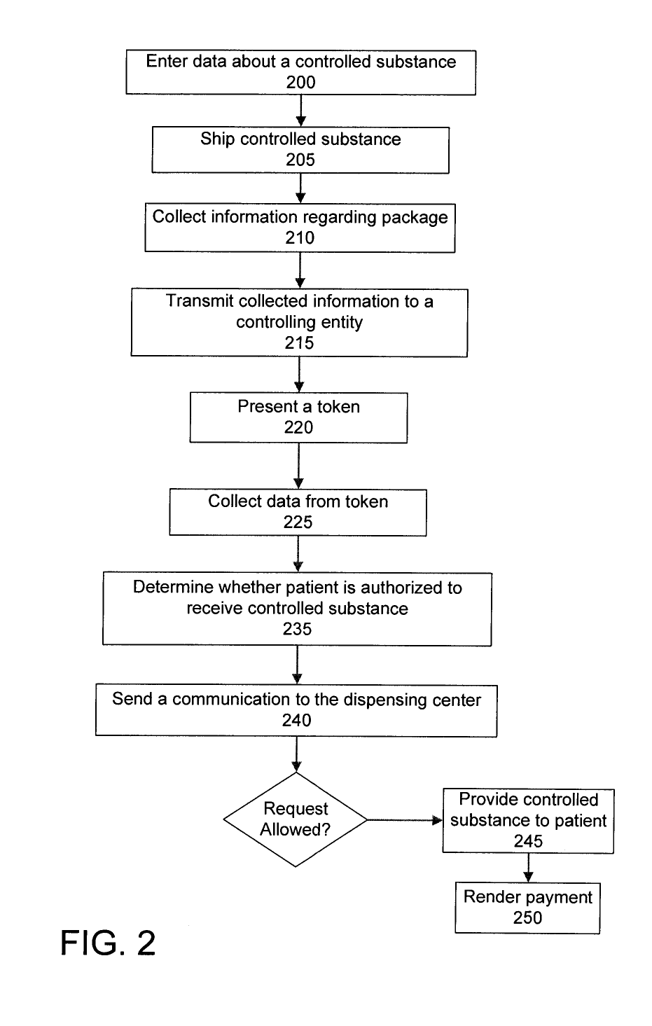

Tracking of a controlled substance may begin at a packaging center 20. A packaging center may include a growing center and/or other location where a controlled substance is prepared and/or packaged. FIG. 2 illustrates an exemplary method of tracking a controlled substance according to an embodiment. In an embodiment, a packaging center 20 may include one or more data entry stations 22 into which data about a controlled substance may be entered 200. For example, a worker may enter 200 information about the packaging center's inventory of a controlled substance, one or more identifiers associated with a care center and/or a dispensing center 30 to which the controlled substance will be delivered, a volume of controlled substance to be delivered, and/or the like.

In an embodiment, a data entry station 22 may be a computer, a mobile electronic device, a workstation and/or another type of computing device equipped with a browser or software to transmit data to a remote data collection point, or to store data in a memory. In an embodiment, entered data may be sent to a controlling entity 50 such as a government agency or other controlling body that monitors data from all aspects of the system. In an embodiment, a controlling entity 50 may be associated with one or more computing devices, databases, and/or the like.

In an embodiment, a controlled substance may be shipped 205 from a packaging center 20 to one or more distribution centers 30. For example, a package of a controlled substance may be shipped 205 from a packaging center 20 to a distribution center 30.

In an embodiment, a dispensing center 30 may be a medical care center, a pharmacy, a physician's office, a hospital and/or another location that has been approved by law to dispense a controlled substance. In an embodiment, a dispensing center 30 may be associated with one or more computing devices, databases and/or the like. When a package of controlled substance is delivered to a dispensing center 30, information regarding the package may be collected 210. In an embodiment, information may be collected by scanning a bar code or other electronic information associated with a package. In an embodiment, information may be collected 210 by manually entering such information into one or more computing devices associated with the dispensing center 30. In an embodiment, information that is collected may include an amount of controlled substance in the package, a type of controlled substance, packaging details and/or other information.

In an embodiment, collected information may be transmitted 215 from a dispensing center 30 to the controlling entity 50. For example, collected information may be transmitted 215 from a dispensing center 30 to the controlling entity 50 via a communications network. In an embodiment, the collected information may be transmitted 215 to the controlling entity 50 at regular intervals, such as once a day. In an embodiment, the collected information may be transmitted 215 to the controlling entity within a time period of being collected at the dispensing center. In an embodiment, collected information may be transmitted 215 to a controlling entity in response to receiving a request for the information from the controlling entity.

In an embodiment, the controlling entity 50 may compare at least a portion of collected information associated with a package of a controlled substance to at least a portion of information about the package that was received from the packaging center 20. For example, the controlling entity 50 may compare the amount of controlled substance the packaging center 20 reported as being included in a package with the amount of controlled substance a dispensing center 30 indicated it received. In an embodiment, if the compared information does not match, the controlling entity 50 may notify the dispensing center, a person, entity, organization, governmental agency, and/or the like.

In an embodiment, a dispensing center 30 may transmit 215 information regarding the inventory of controlled substances at the dispensing center to the controlling entity. For example, a dispensing center 30 may transmit 215 inventory information on a periodic basis, such as monthly, to the controlling entity 50. Data may be entered and transmitted through a data entry station 32, similar to that used by the packaging center 20.

In an embodiment, a patient who has been approved to use a controlled substance may present 220 a token 12 at a dispensing center 30 to purchase the controlled substance. A dispensing center 30 may have a token reader 34 that gathers data from the token. For example, if the token 12 is a card with a magnetic strip, the token reader 34 may be a card reader. As another example, if the token 12 is an RFID tag, the token reader 34 may be an RFID reader.

In an embodiment, a dispensing center 30 may collect 225 data from a token 12 via a token reader 34. For example, a dispensing center worker and/or a patient may swipe a card through a card reader, place an RFID tag within range of an RFID reader and/or the like. In an embodiment, a patient may be required to enter a unique personal identification number (PIN).

In an embodiment, a patient may be required to present government-issued photo identification.

In an embodiment, a PIN may be assigned to a patient by a prescribing physician or entity. In an embodiment, at least a portion of a PIN may correspond to the patient's prescribing physician or entity. A format or structure of a PIN may be indicative of a prescribing physician or entity. For example, patients of Physician A may each be assigned a PIN having ‘1’ as the first digit, while patients of Physician B may each be assigned a PIN having ‘2’ as the first digit. Additional and/or alternate PINs and/or associations may be used within the scope of this disclosure. As such, it may be possible to identify a patient's prescribing physician or entity by examining the patient's PIN. A database or other storage medium of prescribing physicians and/or entities and corresponding PIN identifiers may be maintained by, for example, a controlling entity.

In an embodiment, a patient may present a prescription at a dispensing center. The prescription may include prescription information such as the patient's name, address, the prescribed controlled substance, a prescribed allotment, a prescribed dosage, a prescribing physician, a prescribing medical entity, a unique identifier associated with the prescribing physician or entity, an expiration date and/or the like. In an embodiment, a worker at the dispensing center may enter such information into a data entry station 32.

In an embodiment, a dispensing center 30 may communicate with a controlling entity 50 via a communications network. In an embodiment, a dispensing center 30 may transmit 230 a request to the controlling entity 50. The request may include prescription information, information regarding the patient, the controlled substance a patient is attempting to obtain and/or the like. For example, a request may include a unique identifier associated with a patient, a PIN associated with the patient, a type, amount and/or dosage of the controlled substance that the patient is trying to obtain and/or the like.

In an embodiment, the controlling entity 50 may determine 235 whether the patient is authorized to receive the requested type and/or amount of controlled substance. The controlling entity 50 may maintain a database 52 or other storage medium that includes information relating to one or more patient's controlled substance usage. For example, a database 52 may include a patient's approved allotment of one or more controlled substances for a given time period, data indicating how much substance the patient has received from any dispensing center during the current time period, a PIN associated with the patient and/or the like. Table 1 illustrates an exemplary entry of a controlling entity database 52 according to an embodiment. Additional and/or alternate allotments, controlled substances, time periods, and requested amounts may be used within the scope of this disclosure.

TABLE 1

| | | | | | Previous | | |
|---|---|---|---|---|---|---|---|
| Patient | | Controlled | | Time | request | Amount | |
| Identifier | PIN | Substance | Allotment | Period | date | requested | Allowed/denied |
| 52985 | 7632 | Marijuana | 1 ounce | 1 | May 1, 2011 | 0.50 | Allowed |
| | | | | calendar | | ounce | |
| | | | | month | | | |
| 53210 | 1076 | Marijuana | 1 ounce | 1 | May 1, 2011 | 0.25 | Allowed |
| | | | | calendar | | ounce | |
| | | | | month | May 15, 2011 | 0.25 | Allowed |
| | | | | | | ounce | |

In an embodiment, the controlling entity 50 may retrieve information from its database 52 that pertains to the patient corresponding to a received request. In an embodiment, the controlling entity 50 may use this information to determine 235 whether the request should be allowed or denied.

In an embodiment, the controlling entity 50 may compare the PIN in the received request and the PIN stored in its database that is associated with the patient. If the two PINs do not match, the controlling entity may deny the request. For example, if a request includes a PIN having a value of ‘7633’ for the patient associated with Patient Identifier 52985, the controlling entity 50 may deny the request as the PIN does not match the value ‘7632’ stored in its database 52.

As another example, referring to Table 1, a controlling entity 50 may receive a request indicating that the patient having Patient Identifier 52985 has requested 0.50 ounces of marijuana. The controlling entity 50 may compare the requested controlled substance with the permitted controlled substance associated with the patient. In an embodiment, the controlling entity 50 may compare the requested amount of the controlled substance to the patient's allotment. In an embodiment, the controlling entity 50 may determine whether allowing the request would cause the patient to exceed the patient's allotment for a given time period. For example, with respect to the patient associated with Patient Identifier 52985, the patient is authorized to receive 1 ounce of marijuana every calendar month. If the patient attempts to obtain 0.50 ounces of marijuana on May 20, 2011, the controlling entity 50 may allow the request because it is for the allowed controlled substance and the amount will not cause the patient to exceed his or her allotment for the month.

As another example, if the controlling entity 50 receives a request that the patient associated with Patient Identifier 53210 is trying to obtain 1 ounce of marijuana on May 31, 2011, the controlling entity may deny the request because granting this request would exceed the patient's allotment of marijuana for the month. In an embodiment, an allotment may be determined by regulatory limits, by the patient's prescription, or by a combination of the two (e.g., in some cases a prescription may be no more than a regulatory limit).

In an embodiment, the controlling entity 50 may add the details of a request to its database 52. The controlling entity 50 may send 240 a communication to the dispensing center 30 indicating whether or not the patient is authorized to receive the requested controlled substance. For example, if the request is for an authorized controlled substance and is for an amount that does not cause the patient's total received amount of the controlled substance to exceed the patient's allotment for a time period, the controlling entity 50 may send 240 a communication indicating that the request is approved. In an embodiment, if the request is for an unauthorized controlled substance and/or is for an amount that causes the patient's total received amount of the controlled substance to exceed the patient's allotment for a time period, the controlling entity 50 may send 240 a communication indicating that the request is denied.

In an embodiment, in response to receiving a communication indicating that the request is allowed, the dispensing entity may provide 245 the requested controlled substance to the patient. In an embodiment, the patient may render payment to the dispensing center 30 for the dispensed controlled substance. In an embodiment, a patient may render 250 payment in the form of cash, check, credit card, debit card and/or the like. In an embodiment, a token may be linked to a financial account that enables the user to pay for a controlled substance. For example, a patient's token may be linked to the patient's checking account. If the patient's request for a controlled substance is allowed, the purchase amount may be automatically debited from the patient's checking account. Additional and/or alternate financial accounts such as credit card accounts, savings accounts and/or the like may be used within the scope of this disclosure.

In an embodiment, after the transaction, the dispensing center 30 may transmit 245 to the controlling entity 50 a transaction confirmation that includes the controlled substance dispensed, the amount dispensed, the patient identifier, the date and/or the like. The controlling entity 50 may update 250 its database 52 to include this information.

In an embodiment, a prescribing healthcare professional may be authorized to issue a temporary token to a patient when issuing a prescription. A temporary token may be authorized for use during a limited time period, such as one month, while the patient waits for issuance of a permanent token from the controlling entity. Additional and/or alternate time periods may be used within the scope of this disclosure. Upon expiration of the time period, the temporary token may automatically cease to function or operate.

In an embodiment, the tracking reader 34 and data entry system 32 at each dispensing center 30 may be combined into a single device, or they may be parts of a related system. The system may include a display screen that prompts a worker or patient through various steps of the transaction process. The system also may include an input device (such as a keypad, touchable portion of the screen, or other input) that allows the user to input details of the requested purchase, and optionally enter or approve payment information. In an embodiment, the token reader and/or other parts of the system may be leased from the controlling entity 50.

In an embodiment, a caregiver for a patient may be provided a token. For example, a caregiver may be provided with a token in a situation where a patient cannot go to the dispensing center on his or her own. Such situations may include a patient being confined to his or her home, a patient who is in a nursing or other care facility, a hospital patient and/or the like. A caregiver may be, for example, a registered nurse registered with the controlling entity, a family member, a healthcare provider and/or the like. In an embodiment, information associated with a caregiver may be linked to information associated with the caregiver's patients. When a caregiver visits a dispensing center, the caregiver may present his or her token. Like the patient's token, the caregiver's token may store a unique identifier associated with the patient and/or the caregiver. In an embodiment, a unique identifier associated with a caregiver and/or PINs associated with a caregiver may have a different format than patient identifiers and/or PINs so that dispensing facilities and/or the controlling entity can distinguish patients from caregivers. For example, patients may have 4-digit PIN numbers, while caregivers may have 5-digit PIN numbers. In an embodiment, a caregiver may be limited in the number of patients to which the caregiver may be associated at any one time.

In an embodiment, a caregiver may present the patient's token or other information identifying the patient for whom the caregiver wishes to purchase the controlled substance. Payment may occur by any suitable procedure, such as by the patient over the phone using a credit card, automatically through a patient financial account, or later by an invoice presented to the patient.

The system described above may allow a controlling entity to monitor and track distribution of a controlled substance from the tracking center, to the dispensing center, to the patient. By receiving data about creation of a package of a controlled substance from the packaging center, data about the package's receipt into the dispensing center, and data about the patient to whom the package is dispensed, the system can help ensure that the controlled substance remains within the monitored system through the point of patient delivery.

In an embodiment, the controlling entity may monitor prescription of controlled substances by the prescribing physician, prescribing entity and/or the like. The controlling entity may monitor the number of patients prescribed a controlled substance by the same prescribing physician and/or prescribing entity over a certain time period. For example, the controlling entity may flag a physician who writes more than ten prescriptions for a controlled substance in a month. In an embodiment, prescribing physicians and/or prescribing entities may be tracked by their associated National Provider Identifier (NPI) and/or other unique identifier.

In an embodiment, the controlling entity may monitor the amount of controlled substance prescribed by a prescribing physician and/or prescribing entity. For example, the controlling entity may flag a physician who prescribes more than ten ounces of a controlled substance in a month.

In an embodiment, the controlling entity may notify a person, entity, organization, governmental agency and/or the like of one or more flagged physicians or prescribing entities. For example, a controlling entity may send an email to a governmental agency notifying it of the physicians or prescribing entities that have been flagged.

In an embodiment, the controlling entity may monitor the number of prescribing physicians of prescribing entities associated with a patient over a time period. If a number of prescribing physicians of prescribing entities associated with a patient over a time period exceeds a threshold value, the controlling entity may notify a person, entity, organization, governmental agency and/or the like. For example, if a patient receives a prescription for a controlled substance from two or more physicians within the same month, the controlling entity may notify a governmental agency.

The tracking by the controlling entity may be funded in whole or in part by application processing fees. An initial application fee and a written or digital certification from a medical service provider (e.g., a doctor's prescription) may be required. At certain time periods, such as, for example, each calendar quarter, or every six months, a patient may be required to apply for an extension of a token. The extension fee may be less than the initial application fee, unless the patient has lost the token, in which case the original application fee may be charged. Application for, and renewal of, a token may require a prescription or doctor's recommendation.

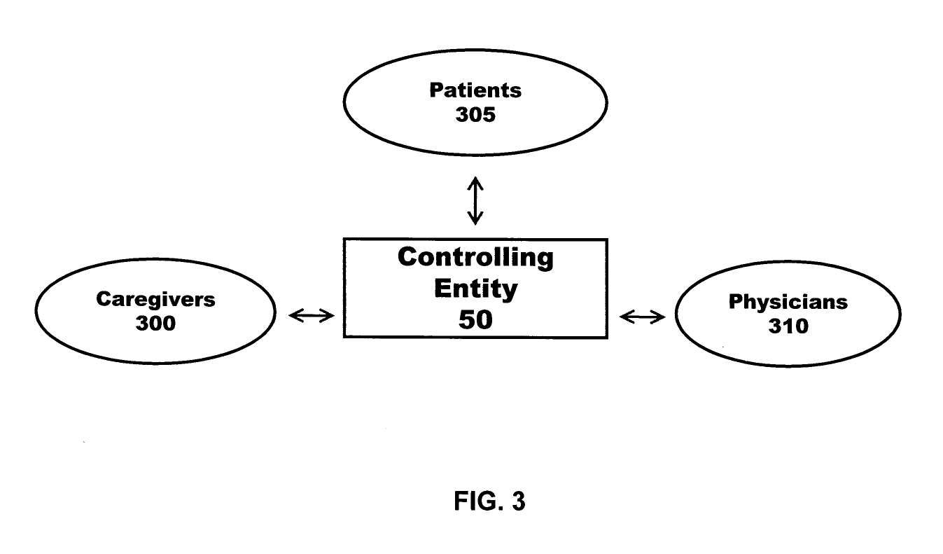

FIG. 3 illustrates exemplary people, entities, organizations and/or the like whose activities the controlling entity may monitor or otherwise track. As illustrated by FIG. 3, a controlling entity 50 may monitor the activities of caregivers 305, patients 310 and/or physicians 315. For example, a controlling entity 50 may monitor the distribution of a controlled substance to a patient and/or a caregiver. In an embodiment, a controlling entity 50 may monitor the prescription of controlled substances by a physician.

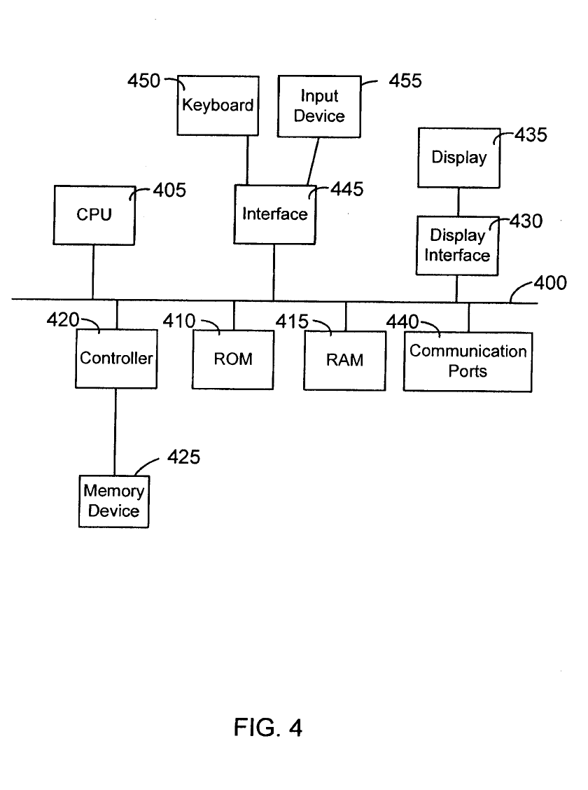

FIG. 4 depicts a block diagram of exemplary internal hardware that may be used to contain or implement program instructions. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 410 and random access memory (RAM) 415 constitute exemplary memory devices.

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 430 may permit information from the bus 400 to be displayed on the display 435 in audio, visual, graphic or alphanumeric format. Communication with external devices, such as a printing device, may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

Various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by this disclosure.

1. A controlled substance distribution system, comprising:
a controlling entity comprising a database, the database comprising:
data associated with a patient,
an amount of a controlled substance that the patient is authorized to receive via disbursement from one or more authorized dispensing entities during a time period, and
an amount of the controlled substance that the patient has already received during the time period;
a patient token having a unique patient identifier, wherein the data in the database includes data that is associated with the unique patient identifier; and
a dispensing center comprising a computing device in communication with the controlling entity, wherein the computing device is configured to:
obtain the unique patient identifier from the patient token,
transmit the unique patient identifier and a request for the controlled substance to the controlling entity,
receive, from the controlling entity, an indication of whether or not the request is allowed, and
authorize a dispensing event in response to the request only if the indication indicates that the request is allowed.

2. The system of claim 1, further comprising a packaging center data entry system that is configured to receive data corresponding to one or more controlled substance packages and transmit the data to the controlling entity before each package is delivered to the dispensing center.

3. The system of claim 1, wherein the request comprises one or more of the following:
a requested controlled substance;
an amount associated with the requested controlled substance; and
a dosage associated with the requested controlled substance.

4. The system of claim 1, wherein the computing device comprises a token reader.

5. The system of claim 1, wherein the computing device is further configured to receive a personalized identification number associated with the patient.

6. The system of claim 1, wherein the computing device is further configured to receive an indication that the patient has presented a valid form of identification.

7. The system of claim 1, further comprising:
a caregiver token having a unique caregiver identifier that is associated with the patient identifier,
wherein the computing device is further configured to obtain the unique caregiver identifier from the caregiver token and transmit the unique caregiver identifier to the controlling entity.

8. The system of claim 1, wherein the token is a temporary token configured to become non-operational after expiration of a second time period.

9. The system of claim 1, wherein the token is linked to a financial account of the patient.

10. The system of claim 1, wherein the dispensing center is configured to receive payment from the patient in response to the indication indicating that the request is allowed.

11. A controlled substance distribution system, comprising:
a controlling entity in communication with a dispensing center, wherein the controlling entity comprises a computing device in communication with a database,
wherein the database comprises:
a unique patient identifier associated with a patient,
an allotted amount of a controlled substance that the patient is authorized to receive via dispensing from one or more authorized dispensing entities during a time period, and
an obtained amount of the controlled substance that the patient has already received during the time period,
wherein the computing device is configured to:
receive a request from the dispensing center to dispense a controlled substance to the patient, wherein the request comprises the patient identifier associated with the patient and a requested amount of the controlled substance,
in response to a sum of the requested amount and the obtained amount exceeding the allotted amount, send a communication to the computing device, wherein the communication comprises an indication that the request is denied.

12. The system of claim 11, wherein the controlling entity is further configured to, in response to the sum of the requested amount and the obtained amount not exceeding the allotted amount, sending a communication to the computing device, wherein the communication comprises an indication that the request is allowed.

13. The system of claim 11, wherein:
the request further comprises a provided personal identifying number,
the database further comprises a personal identifying number associated with the patient, and
the controlling entity is further configured to determine whether the provided personal identifying number matches the personal identifying number.

14. The system of claim 11, wherein:
the request further comprises a provided caregiver identifier,
the database further comprises one or more caregiver identifiers associated with the patient, and
the controlling entity is further configured to determine whether the provided caregiver matches one of the caregiver identifiers.

15. The system of claim 11, wherein:
the database further comprises a prescribing physician associated with the patient,
the computing device is further configured to:
determine whether the prescribing physician has prescribed a number of prescriptions for the controlled substance that exceeds a threshold value over a period of time, and
in response to the prescribing physician prescribing a number of prescriptions for the controlled substance that exceeds the threshold value over the period of time, notifying a party.

16. The system of claim 11, wherein:
the database further comprises a prescribing physician associated with the patient,
the computing device is further configured to:
determine whether the prescribing physician has prescribed an amount of the controlled substance that exceeds a threshold value over a period of time, and
in response to the prescribing physician prescribing an amount of the controlled substance that exceeds the threshold value over the period of time, notifying a party.

17. The system of claim 11, wherein the computing device is further configured to notify a party in response to determining that the patient has been prescribed the control substance by a number of different prescribing parties that exceeds a threshold value over a time period.

18. A controlled substance distribution system, comprising:
a controlling entity in communication with a dispensing center, wherein the controlling entity comprises a computing device in communication with a database, wherein the database comprises:
a patient identifier associated with a patient,
a caregiver identifier associated with a caregiver for the patient,
an allotted amount of a controlled substance that the patient is authorized to receive via dispensing from one or more authorized dispensing entities during a time period, and
an obtained amount of the controlled substance that the patient has already received during the time period,
wherein the computing device is configured to:
receive a request from the dispensing center to dispense a controlled substance to the patient, wherein the request comprises the patient identifier associated with the patient, a provided caregiver identifier and a requested amount of the controlled substance,
in response to the provided caregiver identifier matching the caregiver identifier and a sum of the requested amount and the obtained amount not exceeding the allotted amount, sending a communication to the dispensing center, wherein the communication comprises an indication that the request is allowed.

19. The system of claim 18, wherein the computing device is further configured to:
receive a provided personalized identification number associated with the caregiver; and
determine whether the personalized identification number matches a personalized identification number associated with the caregiver in the database.

20. The system of claim 18, wherein the computing device is further configured to send a communication to the dispensing entity indicating that the request is allowed in response to one or more of the following:
the provided caregiver identifier not matching the caregiver identifier; and
a sum of the requested amount and the obtained amount not exceeding the allotted amount.
